(19) United States
(12) Patent Application Publication
(10) Pub. No.: US 2014/0344078 A1
(43) Pub. Date: Nov. 20, 2014

(54) ELECTRONIC DEVICE, SYSTEM FOR BROADCASTING ADVERTISEMENT AND METHOD THEREOF

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/278,731

(22) Filed: May 15, 2014

(30) Foreign Application Priority Data
May 16, 2013 (CN) 2013101815039

(51) Int. Cl. G06Q 30/02

(52) U.S. Cl. CPC G06Q 30/0277
USPC 705/14.73

(57) ABSTRACT

An method for broadcasting advertisements, includes: obtaining a media file to be shared in response to user operation. Inserting an advertisement into the media file to be shared in response to user operation. Determining at least one recipient selected by the user, and transmitting the media file comprising the advertisement to the at least one selected recipient in response to user operation.

### CROSS REFERENCE TO RELATED APPLICATIONS

This application is related to the following co-pending, commonly assigned patent application, the disclosures of which are incorporated herein by reference in its entirety:

1. “ELECTRONIC DEVICE, SYSTEM FOR INSERTING ADVERTISEMENT TO MEDIA FILES AND METHOD THEREOF” by Steve Lap Wai Hui, whose Attorney Docket No. is US51802.

### FIELD

The present disclosure relates to systems, and particularly to a system for broadcasting advertisement and a method thereof.

### BACKGROUND

Nowadays, in order to enhance awareness of a product, the product may be advertised in a number of ways. For example, the advertisement can be broadcasted via leaflet, television, or networks. However, such advertisement methods may not always be ideal.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a system for broadcasting advertisement.

FIG. 2 is a block diagram of an embodiment of an electronic device.

FIG. 3 is a diagram of a prompt box.

FIG. 4 is a flowchart diagram of an embodiment of a method for broadcasting advertisement.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

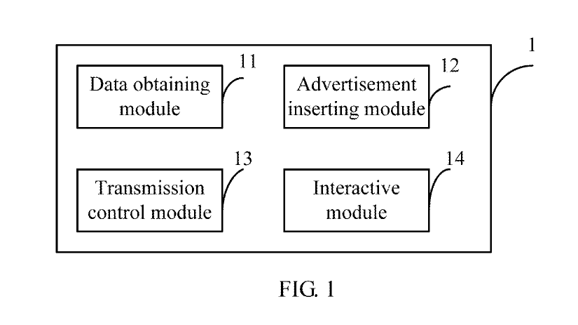

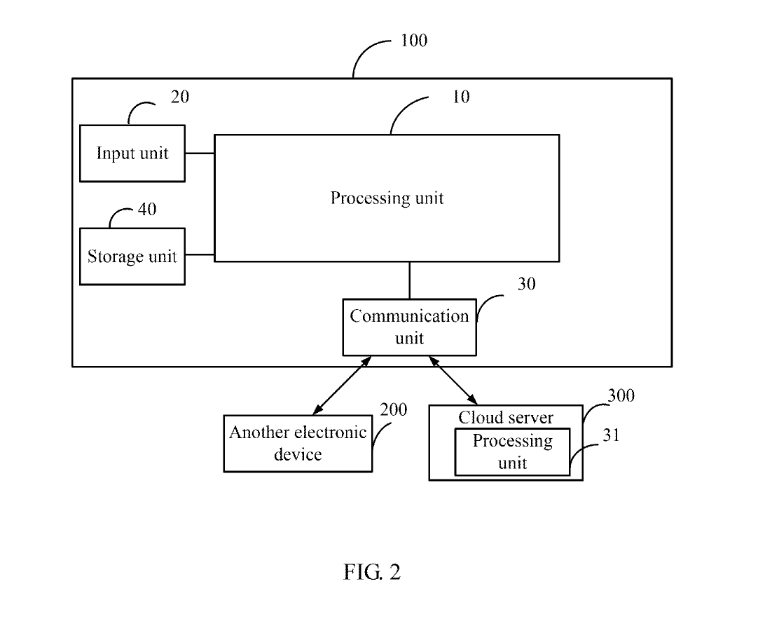

FIGS. 1-2 illustrate a system 1 for broadcasting advertisements of one embodiment. The system 1 can include a data obtaining module 11, an advertisement inserting module 12, a transmission control module 13, and an interactive module 14.

FIG. 2 illustrates that the system 1 is executed by an electronic device 100. The electronic device 100 can include a processing unit 10, an input unit 20, a communication unit 30, and a storage unit 40. In the embodiment, the system 1 can be stored in the storage unit 40, and the modules of the system 1 are a collection of software instructions and can be executed by the processing unit 10. In the embodiment, the storage unit 40 can be a hard disk, a compact disk, or a flash memory. The processing unit 10 can be a central processing unit, a digital processor, or a single chip.

The input unit 20 can be used to input data. The input unit 20 can be a touch screen, a keyboard, or a camera, and the like. The communication unit 30 can communicate with other electronic devices 200 and a cloud server 300 via networks. The network between the electronic device 100, the another electronic devices 200, and the cloud server 300 can be an internet, a wireless network such as WIFI or BLUETOOTH, a telecommunication network such as a GPRS network or a CDMA network, or a broadcasting network, for example.

The electronic device 100 can be a mobile phone, a tablet computer, a desktop computer, or a portable computer, for example. The another electronic device 200 also can be a mobile phone, a tablet computer, a desktop computer, or a portable computer, and can be the same as the electronic device 100 or the different. The cloud server 300 can provide a number of internet services, such as, advertisement services, or data download services, for example.

The storage unit 40 stores a number of media files, the media files can be downloaded from the could server 300, and can be input by the user via the input unit 10, for example, video files captured by a camera. The media files can include video files, audio files, and word documents, for example.

The data obtaining module 11 can be used to obtain a media file to be shared in response to user operation. For example, when the user wants to share the media file with a user of another electronic device 200, the user can select the media file to be shared via the input unit 10 and then send the selected media file to the another electronic device 200. The data obtaining module 11 obtains the media file to be shared in response to the operation of selecting the media file. In the embodiment, the obtained media file can be the media file stored in the storage unit 40 previously, or can be a media file input by the user via the input unit 20 instantly.

The advertisement inserting module 12 can be used to insert an advertisement into the media file to be shared. In the embodiment, the advertisement can be provided by an advertisement provider or the cloud server 300, or can be pre-stored in the storage unit 40. In detail, when the advertisement is provided by the advertisement provider, the advertisement inserting module 12 can link to a source address of the advertisement via a pre-stored website link of the advertisement, and then obtains the advertisement.

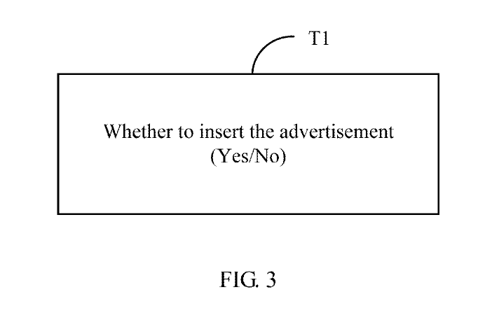

FIG. 3 illustrates that in the embodiment, the advertisement inserting module 12 provides a prompt box T1 to prompt the user whether to insert the advertisement, and the advertisement inserting module 12 inserts the advertisement into the media file to be shared in response to an operation of choosing “Yes” by the user. In the embodiment, the advertisement inserting module 12 can insert a predetermined advertisement into the media file. In at least one embodiment, the advertisement inserting module 12 also can provide an advertisement list including a number of advertisements after the user chooses to insert the advertisement, the advertisement inserting module 12 then can insert a selected advertisement into the media file.

In the embodiment, the advertisement inserted into the media file is before the content of the media file, thus when a user receives the media file and plays the media file, the advertisement is played first, and the content of the media file is displayed only after the advertisement is played completely. In at least one embodiment, the advertisement inserted into the content of the media file, and when the media file is played, the advertisement and the content of the media file can be displayed/played simultaneously. For example, the advertisement and the content media file can be displayed via a multi-screen mode, and are respectively displayed on different screens.

The transmission control module 13 can be used to determine at least one recipient selected by the user and transmit the media file including the advertisement to the at least one selected recipient in response to user operation. In the embodiment, the transmission control module 13 can provide a recipient list for selecting the recipient, and then can determine the at least one recipient according to a selection of the user. In the embodiment, the recipient list can be pre-stored in the storage unit 40.

Because the recipient can be a friend of the user of the electronic device 100, the recipient can read the advertisement inserted in the media file more patiently and the advertisement can be more effective.

In the embodiment, the system 1 can include an interactive module 14. The interactive module 14 can be used to transmit an inquiring information to the recipient after the transmission control module 13 transmits the media file with the advertisement to the at least one selected recipient for a predetermined time, such as 1 hour. In the embodiment, the inquiring information can include content of inquiring whether the recipient read the advertisement and requesting the recipient to give suggestion for the advertisement. The interactive module 14 also can transmit feedback information to the advertisement provider when receiving the feedback information from the recipient. The feedback information can include answers to the inquiring information, such as “Yes”, and suggestion for the advertisement.

In the embodiment, the storage unit 40 can store communication addresses of a number of advertisement providers, the interactive module 14 can determine the advertisement providers providing the advertisement, obtain the communication address of the advertisement provider, and transmit the feedback information to the advertisement provider via the communication address of the advertisement provider. The communication address can be an email address, a telephone number, or a website link, for example.

The cloud server 300 can include a processing unit 31. In at least one embodiment, the system 100 can be run/executed by the processing unit 31. The cloud server 300 can be a social software platform server, such as a Yahoo messenger server.

In at least one embodiment, the data obtaining module 11 can determine the media file to be shared in response to user operation. For example, the user can login in the cloud server 300 according to a registered account number via the electronic device 100 and can select the media file to be shared, and the data obtaining module 11 can determine the media file to be shared according to the selection of the user.

In at least one embodiment, the advertisement inserting module 12 can insert the advertisement into the media file to be shared in response to user operation as follows: the advertisement inserting module 12 inserts the advertisement into the media file to be shared in response to an operation of sharing the media file to friends via the social software platform.

In at least one embodiment, the transmission control module 13 determines at least one recipient according to a selection on a friend list by the user, and transmits share prompting information related to the media file including the advertisement to the at least one selected recipient in response to the user operation. In the embodiment, the share prompting information includes a source address of the media file including the advertisement, and the recipient can access the media file according to the source address of the media file. In another embodiment, the transmission control module 13 can determine the at least one recipient are all of the friends listed in the friend list.

Thus, in the present disclosure, the electronic device 100 can share the media files including the advertisement by transmitting the media file to the recipient directly or sharing the media files to the recipient via the social software platform.

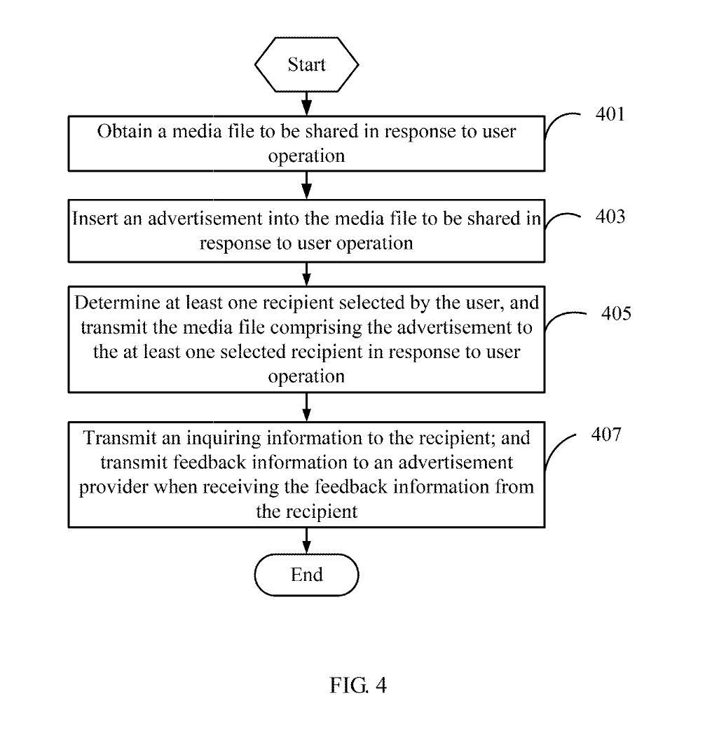

FIG. 4 shows a flowchart of a method for broadcasting advertisements. In 401, the data obtaining module obtains a media file to be shared in response to user operation.

In 403, the advertisement inserting module inserts an advertisement into the media file to be shared in response to user operation. In the embodiment, the advertisement inserting module provides a prompt box to prompt the user whether to insert the advertisement, and the advertisement inserting module inserts the advertisement into the media file to be shared in response to an operation of choosing “Yes” by the user. In the embodiment, the advertisement inserting module inserts a predetermined advertisement into the media file. In another embodiment, the advertisement inserting module also provides an advertisement list including a number of advertisements after the user chooses to insert the advertisement, the advertisement inserting module then can insert the advertisement of the advertisement list selected by the user into the media file.

In 405, the transmission control module determines at least one recipient selected by the user, and transmits the media file including the advertisement to the at least one selected recipient in response to user operation. In the embodiment, the transmission control module provides a recipient list provided for selecting the recipient, and then determines the at least one recipient according to a selection of the user.

In 407, the interactive module transmits an inquiring information to the recipient after the transmission control module transmits the media file including the advertisement to the at least one selected recipient for a predetermined time, and transmits feedback information to the advertisement provider when receiving the feedback information from the recipient.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for broadcasting advertisement, comprising:
a processing unit; and
a plurality of modules which are collection of instructions executed by the processing unit, the modules comprising:
a data obtaining module configured to obtain a media file to be shared in response to user operation;
an advertisement inserting module configured to insert an advertisement into the media file to be shared in response to user operation; and
a transmission control module configured to determine at least one recipient selected by the user, and transmit the media file comprising the advertisement to the at least one selected recipient in response to user operation.

2. The system according to claim 1, wherein the modules of the system is executed by a processing unit of an electronic device, and the media file to be shared is pre-stored in a storage unit of the electronic device, or is inputted by the user via an input unit of the electronic device.

3. The system according to claim 1, wherein the modules of the system is executed by a processing unit of a cloud server, and the media file to be shared is pre-stored in the cloud server, the transmission control module transmits a share prompting information related to the media file comprising the advertisement to the at least one selected recipient in response to user operation, the share prompting information comprises a source address of the media file comprising the advertisement.

4. The system according to claim 1, wherein the advertisement inserting module is further configured to provide a prompt box to prompt the user whether to insert the advertisement, and insert the advertisement into the media file to be shared if the user chooses “Yes”.

5. The system according to claim 4, wherein the advertisement inserting module 12 is further configured to provide an advertisement list comprising a plurality of advertisements after the user chooses to insert the advertisement, the advertisement inserting module then inserts the advertisement selected by the user into the media file.

6. The system according to claim 1, wherein the transmission control module provides a recipient list for selecting the recipient, and then determines the at least one recipient according to a selection of the user.

7. The system according to claim 1, further comprising an interactive module configured to transmit an inquiring information to the recipient after the transmission control module transmits the media file comprising the advertisement to the at least one selected recipient for a predetermined time, and transmit feedback information to the advertisement provider when receiving the feedback information from the recipient.

8. An electronic device comprising:
a storage unit configured to store a plurality of media files;
a communication unit configured to communicate with another electronic devices and a cloud server;
an input unit configured to input data; and
a processing unit, comprising:
a data obtaining module configured to obtain a media file to be shared in response to user operation;
an advertisement inserting module configured to insert an advertisement into the media file to be shared in response to user operation; and
a transmission control module configured to determine at least one recipient selected by the user, and transmit the media file comprising the advertisement to the at least one selected recipient in response to user operation.

9. The electronic device according to claim 8, wherein the media file to be shared is one of the media files pre-stored in a storage unit of the electronic device, or is inputted by the user via an input unit of the electronic device.

10. The electronic device according to claim 8, wherein the advertisement inserting module is further configured to provide a prompt box to prompt the user whether to insert the advertisement, and insert the advertisement into the media file to be shared if the user chooses “Yes”.

11. The electronic device according to claim 10, wherein the advertisement inserting module is further configured to provide an advertisement list comprising a plurality of advertisements after the user chooses to insert the advertisement, the advertisement inserting module then inserts the advertisement selected by the user into the media file.

12. The electronic device according to claim 8, wherein the transmission control module provides a recipient list for selecting the recipient, and then determines the at least one recipient according to a selection of the user.

13. The electronic device according to claim 1, wherein the processing unit further comprises an interactive module, the interactive module is configured to transmit an inquiring information to the recipient after the transmission control module transmits the media file comprising the advertisement to the at least one selected recipient for a predetermined time, and transmit feedback information to the advertisement provider when receiving the feedback information from the recipient.

14. A method for broadcasting advertisement comprising:
obtaining a media file to be shared in response to user operation;
inserting an advertisement into the media file to be shared in response to user operation; and
determining at least one recipient selected by the user, and transmitting the media file comprising the advertisement to the at least one selected recipient in response to user operation.

15. The method according to claim 14, wherein the step of inserting an advertisement into the media file to be shared in response to user operation comprises:
providing a prompt box to prompt the user whether to insert the advertisement;
providing an advertisement list comprising a plurality of advertisements after the user chooses to insert the advertisement; and
inserting the selected advertisement into the media file to be shared if the user chooses “Yes”.

16. The method according to claim 10, further comprising:
transmitting an inquiring information to the recipient after the transmitting the media file comprising the advertisement to the at least one selected recipient for a predetermined time; and
transmitting feedback information to an advertisement provider when receiving the feedback information from the recipient.
